(19) United States
(12) Patent Application Publication
(10) Pub. No.: US 2023/0352220 A1
(43) Pub. Date: Nov. 2, 2023

(54) SINTERED RARE-EARTH MAGNET AND METHOD OF MANUFACTURE

(71) Applicant: Shin-Etsu Chemical Co., Ltd., Tokyo (JP)

(72) Inventors: Hiroshi BABA, Echizen-shi (JP); Hiroki IIDA, Echizen-shi (JP); Mikio YOSHIDA, Echizen-shi (JP); Koichi HIROTA, Echizen-shi (JP)

(73) Assignee: Shin-Etsu Chemical Co., Ltd., Tokyo (JP)

(21) Appl. No.: 18/127,338

(22) Filed: Mar. 28, 2023

(30) Foreign Application Priority Data
Apr. 28, 2022 (JP) 2022-073955

(51) Int. Cl. H01F 1/053; H01F 1/055

(52) U.S. Cl. CPC H01F 1/0536; H01F 1/0556

(57) ABSTRACT

In a sintered rare-earth magnet containing R₂T₁₄B main-phase grains (R being one or more element selected from rare-earth elements and T being one or more element selected from iron group elements), intergranular grain boundaries that from between two mutually adjoining main-phase grains and grain boundary triple junctions surrounded by three or more main-phase grains, the main-phase grains, the intergranular grain boundaries and the grain boundary triple junctions all include TiB₂ crystals. The sintered rare-earth magnet is a to high-performance magnet of high coercivity and good squareness.

### CROSS-REFERENCE TO RELATED APPLICATION

This non-provisional application claims priority under 35 U.S.C, § 119(a) on Patent Application No. 2022-073955 filed in Japan on Apr. 28, 2022, the entire contents of which are hereby incorporated by reference.

### TECHNICAL FIELD

The present invention relates to a sintered rare-earth magnet which is characterized by having an especially high coercivity. The invention further relates to a method for manufacturing such a magnet.

### BACKGROUND ART

The range of application and production volume of sintered R-T-B magnets, as functional materials that are necessary and indispensable to energy savings and higher functionality, is increasing year by year. Such magnets are used in, for example, various types of motors for hybrid vehicles, electric vehicles and consumer electronics. The high coercivity H_{cj} of sintered R-T-B magnets is a major advantage in these various uses, but an increase in H_{cj} is desired in order to further enhance the heat resistance.

In the past, a large amount of heavy rare-earth elements (primarily Dy) was added as a way to increase the H_{cj} of sintered. R-T-B magnets, but a problem with this approach is that the residual flux density Bᵣ decreases with the addition of heavy rare-earth elements. Hence, in recent years, frequent use has come to be made of grain boundary diffusion, which is a method that diffuses heavy rare-earth elements from the surface to the interior of a sintered R-T-B magnet, concentrating the heavy rare-earths in the shell region of main-phase grains and thereby obtaining a high H_{cj} while suppressing a decrease in Bᵣ.

However, the supply of heavy rare-earth elements such as Dy is unstable for a number of reasons, including the limited number of places where they are produced, giving rise to the problem of large price fluctuations. Accordingly, there exists a desire for art that increases the H_{cj} of sintered R-T-B magnets while avoiding to the extent possible the use of Dy and other heavy rare-earth elements.

WO 2013/008756 A1 describes preparing the elemental composition in an R-T-B alloy such as to satisfy a prescribed relationship, thus giving the alloy a composition which contains a lower than normal amount of B. According to the publication, a R₂T₁₇ phase forms in this way and, by using this R₃T₁₇ phase as the starting material and ensuring a sufficient volumetric ratio of a transition metal-rich phase (R₆T₁₃M) formed by reacting the rare-earth element R with a metallic element M, a sintered R-T-B magnet which holds down the Dy content yet has a high coercivity can be obtained.

JP-A 2015-179841 discloses that by mixing together an alloy powder containing 27 to 35 wt % of R, 0.9 to 1.0 wt % of B, 0.15 to 0.6 wt % of Ga and T as the balance with a titanium hydride powder and producing from this a sintered R-T-B magnet, the resulting sintered R-T-B magnet eliminates to the extent possible the use of heavy rare-earth elements and has a high coercivity and squareness while suppressing a decrease in Bᵣ.

However, the sintered R-T-B magnet of WO 2013/008756 A1 has a low squareness compared with ordinary sintered R-T-B magnets, in addition to which the squareness tends to become lower as the H_{cj} rises.

As for the sintered R-T-B magnet of JP-A 2015-179841, although the squareness of this magnet can be made higher, the titanium hydride must be separately prepared and mixed, which increases the number of production steps, resulting in higher production costs.

### SUMMARY OF THE INVENTION

It is therefore an object of the present invention to provide a high-quality sintered R-T-B magnet having a high H_{cj} and squareness without mixing together two alloys.

As a result of intensive investigations, we have discovered that a sintered rare-earth magnet of high H_{cj} and good squareness can be obtained by having the sintered rare-earth magnet include TiB₂ crystals within main-phase grains, within intergranular grain boundaries and within grain boundary triple junctions. Moreover, we have also found that this sintered rare-earth magnet of high H_{cj} and good squareness can be manufactured by a method which, when casting an alloy melt of a prescribed composition to form a starting alloy, optimizes the temperature and cooling rate of the melt.

Accordingly, in a first aspect, the invention provides a sintered rare-earth magnet which contains R₂T₁₄B main-phase grains (where R is one or more element selected from rare-earth elements and T is one or more element selected from iron group elements), intergranular grain boundaries that forms between two mutually adjoining main-phase grains and grain boundary triple junctions surrounded by three or more main-phase grains, wherein the main-phase grains, the intergranular grain boundaries and the grain boundary, triple junctions all include therein TiB₂ crystals.

In a preferred embodiment of the sintered rare-earth magnet of the invention, the TiB₂ crystals have an AlB₂-type crystal structure.

In another preferred embodiment of the inventive magnet, the TiB₂ crystals have a flat hexagonal prismatic shape with an average thickness in a height direction thereof that is from 10 to 60 nm.

In yet another preferred embodiment, the magnet has a composition which consists essentially of 12 to 17 at % of R, 0.1 to 3 at % of M¹ (where M¹ is one or more element selected from Si, Al, Mn, Ni, Cu, Zn, Ga, Ge, Pd, Ag, Cd, In, Sn, Sb, Pt, Au, Hg, Pb and Bi), 0.05 to 1 at % of M² (where M² is one or more element selected from Ti, V, Cr, Zr, Nb, Mo, Hf, Ta and W, with Ti being essential), 4.8 to 6.5 at % of B, up to 1.5 at % of carbon, up to 1.5 at % of oxygen and up to 0.5 at % of nitrogen, with the balance being T. In this preferred, embodiment, M² may include at least 0.05 at % of Ti and at least 0.05 at % of Zr. Also, from 10 to 90 wt % of all grain boundary phases, these being made up of the intergranular grain boundaries and the grain boundary triple junctions, may be R₆T₁₃M¹ phases.

In still another preferred embodiment, the magnet has a mean grain size, defined as the average of the equivalent circle diameters computed from the sectional areas of the main-phase grains, of up to 4 μm.

In a further preferred embodiment, the magnet has a total content of Dy, Tb and Ho which is from 0 to 0.5 at %.

In a second aspect, the invention provides a method for producing the sintered rare-earth magnet according to the first aspect of the invention, which method includes the steps of casting an alloy melt of a predetermined composition to form a starting alloy, milling the starting alloy so as to prepare a fine alloy powder, pressing the fine alloy powder in an applied magnet field to form a compact and heat treating the compact to form a sintered body, wherein the casting step includes raising the alloy melt to a temperature of between 1480° C. and 1600° C. and subsequently cooling the melt while regulating the average rate of cooling down to 500° C. at between 100 and 1.200° C./s and the heat treatment step includes a sintering step that holds the compact within a temperature range of from 950° C. to 1200° C. for between 0.5 to 20 hours.

### ADVANTAGEOUS EFFECTS OF THE INVENTION

This invention makes it possible to obtain high-performance rare-earth sintered magnets having a high H_{cj} and a good squareness.

### BRIEF DESCRIPTION OF THE DIAGRAMS

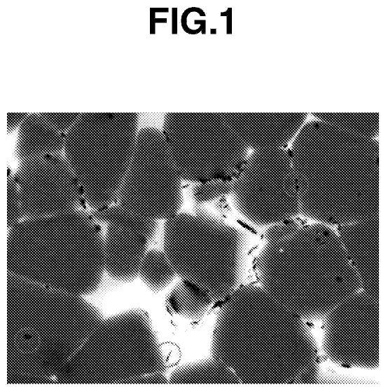

FIG. 1 is an electron probe microanalyzer (EPMA) image of a section of the sintered rare-earth magnet in Example 1.

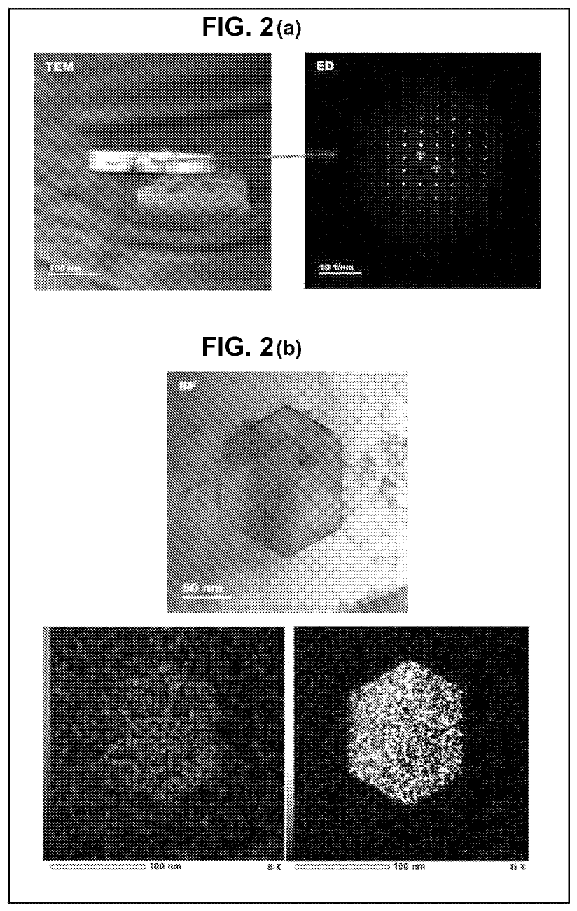

FIG. 2(a) is a STEM-EDX image of a TiB₂ crystal contained in the same sintered rare-earth magnet and an electron beam diffraction pattern for that image, and FIG. 2(b) shows elemental distribution images for B and Ti.

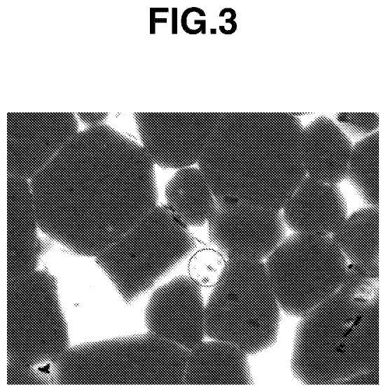

FIG. 3 is an EPMA image of a section of the sintered rare-earth magnet in Comparative Example 2.

### DESCRIPTION OF THE PREFERRED EMBODIMENTS

The objects, features and advantages of the invention will become more apparent from the following detailed description taken in conjunction with the appended diagrams.

As mentioned above, the sintered rare-earth magnet of the invention includes TiB₂ crystals within all of the following: main-phase grains, intergranular grain boundaries, and grain boundary triple junctions.

The sintered rare-earth magnet of the invention is an R-T-B type rare-earth magnet. Although not particularly limited, it preferably has a composition which consists essentially of 12 to 17 at % of R, 0.1 to 3 at % of M¹, 0.05 to 1.0 at % of M², 4.8 to 6.5 at % of B, up to 1.5 at % of carbon, up to 1.5 at % of oxygen and up to 0.5 at % of nitrogen, with the balance being T.

R is at least one element selected from rare-earth elements, with Nd preferably, being essential. The ratio of Nd in R is preferably at least 60 at %, and more preferably at least 75 at %. Although the content of R is not particularly limited, to suppress excessive decreases in the H_{cj} and Bᵣ of the sintered rare-earth magnet, the content is preferably from 12 to 17 at %, and more preferably from 13 to 16 at %. R need not include Dy, Tb and Ho. However, when they are included, the total amount of Dy, Tb and Ho with respect to the overall sintered rare-earth magnet is preferably not more than 5.0 at % (from 0 to 5.0 at %).

M¹ is one or more element selected from Si, Al, Mn, Ni, Cu, Zn, Ga, Ge, Pd, Ag, Cd, In, Sn, Sb, Pt, Au, Hg, Pb and Bi. Although the content of M¹ is not particularly limited, to ensure a good abundance of R—Fe(Co)-M¹ grain boundary phases and obtain a sufficient H_{cj} increasing effect, and also to suppress a worsening in the squareness of the magnet and a decrease in Bᵣ, the content is preferably from 0.1 to 3 at %, and more preferably from 0.5 to 2.5 at %.

M² is one or more element selected from Ti, V, Cr, Zr, Nb, Mo, Hf, Ta and W, with Ti being essential. Although the content of M² is not particularly limited, to stably form the boride and suppress abnormal grain growth during sintering, the content is preferably from 0.05 to 1.0 at %, and more preferably from 0.1 to 0.5 atom %. In this way, sintering at a relatively high temperature is possible during production, which leads to an improved squareness and better magnetic properties.

Although not particularly limited, M² preferably includes at least 0.05 at % of Ti and at least 0.05 at % of Zr, and more preferably includes at least 0.1 at % of Ti and at least 0.2 at % of Zr.

The boron is not particularly limited. In the viewpoint of preventing that hindering an increase in Hcj due to forming a R₁₁Fe₄B₄ compound phase, which is a boron-rich phase, and maintaining good magnetic properties by ensuring the volumetric ratio of the main phase, the boron content is preferably from 4.8 to 6.5 at %, and more preferably from 5.0 to 6.2 at %.

It is desirable for the oxygen, carbon and nitrogen contents of the sintered rare-earth magnet of the invention to be low, but completely avoiding the incorporation of these elements in the production steps is difficult. The oxygen content is preferably not more than 1.5 at %, more preferably not more than 1.2 at %, even more preferably not more than 1.0 at %, and most preferably not more than 0.8 at %. The carbon content is preferably not more than 1.5 at %, and more preferably not more than 1.3 at %. The nitrogen content is preferably not more than 0.5 at %, and more preferably not more than 0.3 at %. Although it is acceptable for elements such as H, F, Mg, P, S, Cl and Ca to be present as impurities in amounts of not more than 0.1 wt % the content of these elements too should be low.

T is one or more element selected from iron group elements. This T preferably includes Fe, and may additionally include Co. T is included as the balance of the composition, the content of T being preferably from 70 to 80 at %, and more preferably from 75 to 80 at %. As noted above, Co may or may not be included, although an amount of Co representing typically up to 10 at %, preferably up to 5 atom %, of the overall composition of the rare-earth sintered magnet may be included in T for the purpose of increasing the Curie temperature and the corrosion resistance. Co substitution in excess of 10 at % leads to a large decrease in H_{cj} and is therefore undesirable.

The sintered rare-earth magnet of the invention has a mean grain size of preferably 4 μm or less, and the degree of orientation of the c-axis, which is the axis of easy magnetization, in R₂Fe₁₄B grains is preferably at least 98%. Measurement of the mean grain size may be carried out as follows. First, a section of the sintered magnet is mirror polished and subsequently immersed in an etchant such as Vilella's reagent (a mixture of glycerin, nitric acid and hydrochloric acid in a 3:1:2 ratio), following which the section where the grain boundary phases have been selectively etched is examined with a laser microscope, Based on the resulting image, the sectional areas of individual grains are measured by image analysis and their equivalent circle diameters are computed. The mean grain size is then calculated based on data on the areal fraction occupied by each grain. The mean grain size was taken to be the average for a total of about 2,000 grains in the images at 20 different places. The mean grain size of the sintered body can be controlled by adjusting the mean particle size of the fine alloy powder for the sintered magnet during fine milling.

The sintered rare-earth magnet of the invention has a microstructure in which the R₂T₁₄B phase serves as the main phase and which includes grain boundary phases between two mutually adjoining main-phase grains, and grain boundary triple junctions surrounded by three or more main-phase grains. The intergranular grain boundaries and the grain boundary triple junctions may be ones which include R₆T₁₃M¹₁, R-M¹ and M²-B₂ phases. The sintered magnet of the invention contains TiB₂ crystals within the main phase, within the intergranular grain boundaries and within the grain boundary triple junctions.

The TiB₂ crystals have an AlB₂ type crystal structure. Their identification can be carried out by STEM-EDX. The crystals have a fiat hexagonal prismatic shape with an average thickness in the height direction thereof which is preferably from 10 to 60 nm. The reason for the improvement in the properties of the sintered rare-earth magnet with the adoption of such a microstructure, although not entirely clear, is conjectured to be as follows. Namely, it is thought that because the TiB₂ crystals precipitate within the main phase, within the intergranular grain boundaries and within the grain boundary triple junctions, these crystals have the desirable effect of suppressing abnormal grain growth in the sintered body and moreover function as spacers which weaken the magnetic bonds between main-phase grains, thus helping to increase coercivity and increase squareness.

Such a microstructural morphology appears to be obtainable owing to production of the alloy with the addition of Ti. Also, it appears that the Ti within the cast alloy is in solid solution in the main phase, and that by carrying out sintering, it precipitates out as TiB₂ within the main phase, within the grain boundary phases and within the grain boundary triple junctions.

It is preferable for the intergranular grain boundaries and the grain boundary triple junctions to include an R₆T₁₃M¹₁ phase in a volumetric ratio of preferably 10 to 90%, and more preferably 50 to 80%. By setting the amount in this range, a sufficiently high H_{cj} is obtained and a large decrease in Bᵣ can be suppressed.

Although not particularly limited, M¹ in the R₆T₁₃M¹₁ phase is preferably such that Si accounts for 0.5 to 50 at % of M¹, with the balance of M¹ being one or more element selected from Al, Mn, Ni, Cu, Zn, Ga, Ge, Pd, Ag, Cd, In, Sn, Sb, Pt, Au, Hg, Pb and such that Ga accounts for 1.0 to 80 at % of M¹, with the balance of M¹ being one or more element selected from Si, Al, Mn, Ni, Cu, Zn, Ge, Pd, Ag, Cd, In, Sn, Sb, Pt, Au, Hg, Pb and Bi; or such that Al accounts for 0.5 to 50 at % of M¹, with the balance of M¹ being one or more element selected from Si, Mn, Ni, Cu, Zn, Ga, Ge, Pd, Ag, Cd, In, Sn, Sb, Pt, Au, Hg, Pb and Bi.

These elements can stably form intermetallic compounds (e.g., R₆Fe₁₃Ga₁, R₆Fe₁₃Si₁, etc.) and mutually substitute M¹ sites. Even when a combination of elements are present at the M¹ sites, conspicuous differences in the magnetic properties are not observable. In fact, stabilization in the quality due to reduced variability of the magnetic properties, and cost reductions owing to a decrease in the amount of expensive elements added are achievable.

In addition to the above main phase, intergranular grain boundaries and grain boundary triple junctions, the rare-earth sintered magnet of the invention may additionally include R-rich phases and phases containing unavoidable elements that are incorporated during production, such as R oxides, R carbides, R nitrides, R halides and R oxyhalides.

A method for producing the sintered rare-earth magnet of the invention shall now be described. The inventive method for manufacturing a sintered rare-earth magnet is a method for manufacturing the above-described sintered rare-earth magnet of the invention, and involves milling an alloy of a predetermined composition, pressing the milled alloy in an applied magnetic field, and sintering the resulting compact.

In the manufacturing method of the invention, the steps involved in producing an alloy for sintered R—Fe—B rare-earth magnets can be carried out in basically the same way as in a conventional powder metallurgy process. That is, although not particularly limited, the manufacturing method of the invention typically includes a casting step which melts a raw material having a predetermined composition and casts the resulting alloy melt to form a starting alloy, a milling step which mills the starting alloy so as to prepare a fine alloy powder, a pressing step which presses the fine alloy powder in an applied magnet field to form a compact, and a heat treatment step which heat treats the compact to form a sintered body. Here, the heat treatment step includes a sintering step which sinters the compact and may additionally include a heat treatment step which subjects the sintered magnet to heat treatment. Also, the milling step may include a coarse milling step which forms a coarsely milled powder and a fine milling step which forms a finely milled powder.

First, in the casting step, the metals or alloys serving as the sources of the various elements are weighed out so as to give the above-described predetermined composition in the invention. This raw material is then melted such as by high-frequency heating, and the resulting alloy melt is cooled and cast to produce a starting alloy. As mentioned above, the sintered rare-earth magnet of the invention can be produced by adding Ti during production of the alloy. More specifically, in the above casting step, when melting the raw material having a predetermined composition that includes Ti, the temperature of the alloy melt is raised to between 1480° C. and 1600° C., preferably between 1500° C. and 1550° C., following which cooling is carried out while regulating the average rate of cooling down to 500° C. at between 100 and 1200° C./s, and preferably between 500 and 1000° C./s. In this way, an alloy microstructure containing Ti in solid solution within the main phase is obtained. When the cooling rate is lower than 100° C./s, coarse TiB₂ crystals precipitate out in the course of cooling and so a magnet in which fine TiB₂ crystals are dispersed is not obtained. On the other hand, when the cooling rate exceeds 1200° C./s, chill crystals and amorphous phases form within the alloy structure, lowering the magnetic properties of the magnet.

The milling step is a multi-stage step that includes, for example, a coarse milling step and a fine milling step. A jaw crusher, Braun mill, pin mill or hydrogen decrepitation, for example, may be used in the coarse milling step. In the case of an alloy produced by strip casting, a coarse powder that has been coarsely milled to a size of, for example, from 0.05 to 3 mm, especially from 0.05 to 1.5 mm, can generally be obtained by employing hydrogen decrepitation.

In the fine milling step, a lubricant is added to the coarse powder obtained in the coarse milling step, and fine milling is carried out using a method such as jet milling.

In this fine milling step within the manufacturing method of the invention, fine milling is carried out so as to set the mean particle size of the fine powder within a range of preferably 0.5 to 3.5 μm. The mean particle size of the fine powder in this case is more preferably from 1.0 to 3.0 μm, and even more preferably from 1.5 to 2.8 μm. The lower limit value of 0.5 lien is set with the aim of suppressing oxidation and nitridation of the fine powder and of obtaining a good H_{cj}. The upper limit value of 3.5 μm is set with the aim of obtaining a sufficient H_{cj}. The mean particle size of the powder refers to the median diameter in volume-based particle size analysis measured by the laser diffraction method.

The fine powder prepared in this manner is pressed in an applied magnetic field to form a compact, and the compact is heat treated to form a sintered body, thereby giving a sintered magnet.

In the pressing step, the alloy powder should be compacted with a press while applying a 400 to 1,600 kA/m magnetic field to orient the powder in the direction of easy magnetization.

In the sintering step, the compact obtained in the pressing step is sintered in a non-oxidizing atmosphere such as a high vacuum or argon gas. In this invention, the sintering operation is carried out while holding the compact in a temperature range of between 950° C. and 1200° C., preferably between 1000° C. and 1150° C., for a period of 0.5 to 20 hours, preferably 3 to 10 hours. In this way, a magnet microstructure is obtained wherein the Ti that was in solid solution in the main phase has precipitated as TiB₂ within the main phase, within the grain boundary phases and within the grain boundary triple junctions. At a sintering temperature below 950° C., densification of the compact does not fully proceed; at a sintering temperature above 1200° C., abnormal grain growth arises. When the holding temperature is less than 0.5 hour, the amount of precipitation by TiB₂ crystals is insufficient; when it exceeds 20 hours, coarsening of the TiB₂ crystals arises.

Following the sintering step, although not particularly limited, heat treatment at a lower temperature than the sintering temperature may be carried out in order to increase the H_{cj}. This post-sintering heat treatment may be carried out as two-stage heat treatment consisting of high-temperature heat treatment and low-temperature heat treatment, or low-temperature heat treatment alone may be carried out. In such post-sintering heat treatment, the sintered body is preferably heat-treated at a temperature of between 600° C. and 950° C. in high-temperature heat treatment, and is preferably heat-treated at a temperature between 400° C. and 600° C. in low-temperature heat treatment. Cooling down to at least 400° C. is then carried out at a cooling rate of between 5 and 100° C./min, preferably between 5 and 80° C./min, and more preferably between 5 and 50° C./min. At a cooling rate below 5° C./min, the R₆T₁₃M¹₁ phase segregates to grain boundary triple junctions, as a result of which the magnetic properties may markedly worsen. On the other hand, at a cooling rate greater than 100° C./min, segregation of the R₆T₁₃M¹₁ phase in the course of cooling can be suppressed, but the dispersibility of R-M¹ phases within the microstructure is inadequate, as a result of which the squareness of the sintered magnet may worsen.

The resulting sintered magnet may be subjected to grain boundary diffusion treatment using Dy and Tb. By reducing the nitrogen concentration in the manner described above to 800 ppm or below, stable properties can be obtained without lowering the increase in H_{cj} following grain boundary diffusion.

### EXAMPLES

The invention is illustrated more fully below by way of Examples and Comparative Examples, although the invention is not limited by these Examples.

### Examples 1 to 5. Comparative Examples 1 to 4

In each of these Example, a rare-earth metal (Nd or didymium), electrolytic iron, Co and other metals and alloys were weighed out so as to give a predetermined composition and melted in a high-frequency induction furnace under an argon gas atmosphere, following which an alloy ribbon was produced by strip casting the molten alloy on a water-cooled copper roll. The molten alloy ramp-up temperature and cooling rate at this time were varied in the respective Examples and Comparative Examples. These conditions are shown in Table 2. The alloy ribbon thus produced was then coarsely milled to give a coarse powder, following which 0.20 wt % of menthol was added as a lubricant to the coarse powder and mixed therein. The resulting coarse powder was then finely milled with a jet mill in a stream of nitrogen, producing a fine powder. Next, the fine powder was charged, within an inert gas atmosphere, into the mold of a powder-compacting press and, while being oriented in a 15 kOe (1.19 MA/m) magnetic field, was pressed in a direction perpendicular to the magnetic field. The resulting compact was sintered in a vacuum at between 1030° C. and 1080° C. for 5 to 30 hours and then cooled to 200° C. or below. The sintered body was subjected to 2 hours of post-sintering heat treatment at 900° C. and then cooled to 200° C., following which 2 hours of aging treatment was carried out. The magnet compositions in the respective examples are shown in Table 1.

The center portion of each of the resulting sintered bodies was cut out into a rectangular parallelepiped shape having dimensions of 18 mm×15 mm×12 mm to give a sintered magnet, and the magnetic properties of each sintered magnet were measured using a B—H tracer. Table 2 shows the respective values obtained in Examples 1 to 5 and Comparative Examples 1 to 4, The oxygen concentrations of the sintered magnets were measured by the inert gas fusion-infrared absorption method, the nitrogen concentrations were measured by the inert gas fusion-thermal conductivity method and the carbon concentration was measured by the combustion-infrared absorption method, The mean grain size D50 (μm) was determined as follows. A section of the sintered magnet in a direction parallel to the direction of magnetization was mirror polished, then immersed in a mixed solution of glycerin, nitric acid and hydrochloric acid in a ratio of 3:1:2, thereby selectively etching the grain boundary phases on the section. Twenty-five sectional images of 85×85 μm regions were then taken with a laser microscope. Based on these images, the sectional areas of individual grains were measured by image analysis and the mean grain size was determined as the area average for the diameters of the grains computed as equivalent circle diameters.

Upon examination of a section of the sintered magnet produced in Example 1 with an electron probe microanalyzer (EPMA), as shown in FIG. 1, R₂T₁₄B was the main phase, in addition to which grain boundary phases that form between two mutually adjoining main-phase grains and grain boundary triple junctions surrounded by three or more main-phase grains were observed. The intergranular grain boundaries and the grain boundary triple junctions included R₆T₁₃M¹₁, R-M¹₁ and M²-B₂ phases. R₆T₁₃M¹₁ phases accounted for 75 vol % of all the grain boundary phases. Also, TiB₂, crystals were included within the main phase, within the intergranular grain boundaries and within the grain boundary triple junctions. STEM-EDX examination of the TiB₂ crystals demonstrated that, as shown in FIG. 2(a), these crystals had a AlB₂ type crystal structure. In addition, as shown in FIG. 2(b), it is apparent that the crystal shape was a flat hexagonal prismatic shape and that the average thickness in the height direction of the hexagonal prismatic shape was about 40 nm. In FIG. 3, which is an EPMA image of a section of the sintered magnet produced in Comparative Example 2, it is apparent that ZrB₂ crystals have segregated within the grain boundary triple junctions.

TABLE 1

| | | | | | | | | | | | Oxygen | Nitrogen | Carbon |
|---|---|---|---|---|---|---|---|---|---|---|---|---|---|
| | | | | | | | | | | (Al, Cu, | concen- | concen- | concen- |
| | | Nd | Pr | Fe | Co | B | Ti | Zr | Hf | Si, Ga) | tration | tration | tration |
| | | (at %) | (at %) | (at %) | (at %) | (at %) | (at %) | (at %) | (at %) | (at %) | (at %) | (at %) | (at %) |
| Example | 1 | 11.1 | 3.4 | balance | 1.0 | 5.6 | 0.5 | 0 | 0 | 1.9 | 0.30 | 0.24 | 0.77 |
| | 2 | 11.8 | 3.4 | balance | 1.0 | 5.7 | 0.5 | 0 | 0 | 1.9 | 0.30 | 0.26 | 0.76 |
| | 3 | 11.3 | 3.5 | balance | 1.0 | 5.6 | 0.5 | 0 | 0 | 1.9 | 0.34 | 0.26 | 0.80 |
| | 4 | 11.4 | 3.1 | balance | 1.0 | 5.7 | 0.2 | 0.3 | 0 | 1.9 | 0.45 | 0.21 | 0.72 |
| | 5 | 11.4 | 3.1 | balance | 1.0 | 5.7 | 0.3 | 0 | 0.2 | 1.9 | 0.43 | 0.24 | 0.76 |
| Comparative | 1 | 11.1 | 3.4 | balance | 1.0 | 5.0 | 0 | 0.5 | 0 | 1.9 | 0.41 | 0.24 | 0.72 |
| Example | 2 | 11.1 | 3.4 | balance | 1.0 | 5.8 | 0 | 0.5 | 0 | 1.9 | 0.37 | 0.25 | 0.73 |
| | 3 | 11.1 | 3.4 | balance | 1.0 | 5.6 | 0.5 | 0 | 0 | 1.9 | 0.33 | 0.25 | 0.77 |
| | 4 | 11.1 | 3.4 | balance | 1.0 | 5.6 | 0.5 | 0 | 0 | 1.9 | 0.30 | 0.24 | 0.77 |

TABLE 2

| | | | | | Fine | | | Aging | | | | | M²—B₂ | M²—B₂ | |
|---|---|---|---|---|---|---|---|---|---|---|---|---|---|---|---|
| | | Alloy | Alloy | Chill | powder | Sin- | Sin- | treat- | | | | M²—B₂ | in inter- | in grain | Mean |
| | | ramp-up | cooling | crystals | particle | tering | tering | ment | | | | in | granular | boundary | grain |
| | | temp. | rate | in | size | temp. | time | temp. | Bᵣ | H_{cJ} | Hₖ—H_{cJ} | main | grain | triple | size |
| | | (° C.) | (° C./s) | alloy | (μm) | (° C.) | (h) | (° C.) | (kG) | (kOe) | (kOe) | phase | boundaries | junctions | (μm) |
| Example | 1 | 1,550 | 700 | no | 2.4 | 1,080 | 5 | 450 | 13.1 | 21.6 | −0.2 | yes | yes | yes | 2.9 |
| | 2 | 1,500 | 800 | no | 2.4 | 1,070 | 5 | 450 | 13.0 | 22.0 | −0.4 | yes | yes | yes | 2.9 |
| | 3 | 1,550 | 800 | no | 2.1 | 1,070 | 5 | 450 | 13.1 | 21.6 | −0.3 | yes | yes | yes | 2.6 |
| | 4 | 1,550 | 700 | no | 2.4 | 1,080 | 5 | 450 | 13.3 | 20.7 | −0.3 | yes | yes | yes | 3.0 |
| | 5 | 1,550 | 800 | no | 2.4 | 1,070 | 5 | 450 | 13.3 | 21.0 | −0.4 | yes | yes | yes | 2.9 |
| Comparative | 1 | 1,550 | 700 | no | 2.4 | 1,050 | 5 | 470 | 13.0 | 22.0 | −4.5 | no | no | no | 3.0 |
| Example | 2 | 1,550 | 700 | no | 2.4 | 1,080 | 5 | 450 | 13.1 | 19.7 | −0.2 | no | no | yes | 3.0 |
| | 3 | 1,550 | 50 | no | 2.4 | 1,070 | 5 | 450 | 13.2 | 18.5 | −0.5 | no | no | yes | 2.9 |
| | 4 | 1,550 | 700 | no | 2.4 | 1,070 | 30 | 450 | 13.1 | 19.1 | −1.2 | no | no | yes | 3.0 |

As shown in Table 2 and FIGS. 1 to 3, magnets which contain TiB₂ crystals in the main phase, in the intergranular grain boundaries and in grain boundary triple junctions have both a high H_{cj} and a good squareness, and therefore can be employed in various applications as high-performance magnets.

Japanese Patent Application No. 2022-073955 is incorporated herein by reference.

Although some preferred embodiments have been described, many modifications to and variations may be made thereto in light of the above teachings. It is therefore to be understood that the invention may be practiced otherwise than as specifically described without departing from the scope of the appended claims.

1. A sintered rare-earth magnet comprising R₂T₁₄B main-phase grains (where R is one or more element selected from rare-earth elements and T is one or more element selected from iron group elements), intergranular grain boundaries that form between two mutually adjoining main-phase grains and grain boundary triple junctions surrounded by three or more main-phase grains, wherein the main-phase grains, the intergranular grain boundaries and the grain boundary triple junctions all contain TiB₂ crystals.

2. The sintered rare-earth magnet of claim 1, wherein the TiB₂ crystals have an AlB₂-type crystal structure.

3. The sintered rare-earth magnet of claim 1, wherein the TiB₂ crystals have a flat hexagonal prismatic shape with an average thickness in a height direction thereof that is from 10 to 60 nm.

4. The sintered rare-earth magnet of claim 1, wherein the magnet has a composition which consists essentially of 12 to 17 at % of R, 0.1 to 3 at % of M¹ (where M¹ is one or more element selected from Si, Al, Mn, Ni, Cu, Zn, Ga, Ge, Pd, Ag, Cd, In, Sn, Sb, Pt, Au, Hg, Pb and Bi), 0.05 to 1 at % of M² (where M² is one or more element selected from Ti, V, Cr, Zr, Nb, Mo, Hf, Ta and W, with Ti being essential), 4.8 to 6.5 at % of B, up to 1.5 at % of carbon, up to 1.5 at % of oxygen and up to 0.5 at % of nitrogen, with the balance being T.

5. The sintered rare-earth magnet of claim 4, wherein M² includes at least 0.05 at % of Ti and at least 0.05 at % of Zr.

6. The sintered rare-earth magnet of claim 4, wherein 10 to 90 vol % of all grain boundary phases, comprising the intergranular grain boundaries and the grain boundary triple junctions, are R₆T₁₃M¹ phases.

7. The sintered rare-earth magnet of claim 1, wherein the magnet has a mean grain size, defined as the average of the equivalent circle diameters computed from sectional areas of the main-phase grains, of up to 4 μm.

8. The sintered rare-earth magnet of claim 1, wherein the magnet has a total content of Dy, Tb and Ho which is from 0 to 0.5 at %.

9. A method for producing the sintered rare-earth magnet of claim 1, comprising the steps of:
casting an alloy melt of a predetermined composition to form a starting alloy,
milling the starting alloy to prepare a fine alloy powder,
pressing the fine alloy powder in an applied magnet field to form a compact, and
heat treating the compact to form a sintered body;
wherein the casting step comprises raising the alloy melt to a temperature of between 1480° C. and 1600° C. and subsequently cooling the melt while regulating the average rate of cooling down to 500° C. at between 100 and 1200° C./s, and the heat treatment step includes a sintering step that holds the compact within a temperature range of 950° C. to 1200° C. for between 0.5 and 20 hours.
